(19) United States
(12) Patent Application Publication
(10) Pub. No.: US 2026/0158433 A1
(43) Pub. Date: Jun. 11, 2026

(54) Containment system and method for carbon capture device

(71) Applicant: Equinor Low Carbon UK Limited, London (GB)

(72) Inventors: Gervas Franceschini, Derby (GB); Martin Mills, Derby (GB)

(21) Appl. No.: 19/128,877

(22) PCT Filed: Oct. 30, 2023
(86) PCT No.: PCT/EP2023/080257

§ 371 Date: May 9, 2025

(30) Foreign Application Priority Data
Nov. 10, 2022 (GB) 2216766.2

(51) Int. Cl. B01D 53/14; B01D 39/18

(52) U.S. Cl. CPC B01D 53/1475; B01D 39/18; B01D 2201/31; B01D 2257/50; B01D 2258/06

(57) ABSTRACT

A containment system for a carbon capture device includes a primary bund at least partially surrounding the carbon capture device and configured to receive therein a process fluid spilled from the carbon capture device and a rainwater. The rainwater and the process fluid spilled from the carbon capture device at least partially forms a fluid stored within the primary bund. The containment system further includes at least one secondary bund configured to receive therein at least a portion of the fluid stored within the primary bund. The containment system further includes at least one first plant species disposed within the at least one secondary bund and configured to at least partially filter the portion of the fluid received within the at least one secondary bund.

### FIELD OF THE DISCLOSURE

The present disclosure generally relates to a containment system and a method for a carbon capture device.

### BACKGROUND

Bunding is generally utilized across plants, such as plants for direct air capture (DAC) of carbon dioxide (CO₂), as a means to capture a spill from such plants. For example, sorbents and solvents tend to leak from equipment, such as absorbers, desorbers, heat exchangers, tanks, and pipelines. Sorbent and solvent losses may form a major proportion of cost in such plants. Generally, plants include a concrete bund area under the equipment to collect spillage. Liquid entering the concrete bund area is required to be taken away and treated by specialist waste contractors.

### SUMMARY

According to a first aspect, there is provided a containment system for a carbon capture device. The containment system includes a primary bund at least partially surrounding the carbon capture device and configured to receive therein a process fluid spilled from the carbon capture device and a rainwater. The rainwater and the process fluid spilled from the carbon capture device at least partially form a fluid stored within the primary bund. The containment system further includes at least one secondary bund disposed in fluid communication with the primary bund. The at least one secondary bund is configured to receive therein at least a portion of the fluid stored within the primary bund. The containment system further includes at least one first plant species disposed within the at least one secondary bund. The at least one first plant species is configured to at least partially filter the portion of the fluid received within the at least one secondary bund.

The primary bund of the containment system is configured to receive the process fluid spilled from the carbon capture device, e.g., in case of leakage in associated pipework, tanks, equipment, etc. Thus, the primary bund may prevent the process fluid from entering an environment around a site of the carbon capture device, thereby protecting the environment from direct exposure to the process fluid. Further, the primary bund is open to collect the rainwater runoff from the carbon capture device or associated regions around the carbon capture device. Thus, the primary bund may not only function as a first containment measure for any leakage through the carbon capture device, but also mitigate environmental impact of the process fluid by diluting the process fluid using the rainwater.

The at least one first plant species disposed within the at least one secondary bund may include naturally planted beds that may at least partially filter the portion of the fluid received within the at least one secondary bund. For example, the at least one secondary bund may further break down the low-level concentration of the process fluid in the portion of the fluid received within the at least one secondary bund and may simultaneously filter, clean, and purify the portion of the fluid. Thus, the at least one secondary bund may function as a natural wastewater treatment system, thereby reducing a need to clean the fluid through specialist waste contractors. This may reduce an overall cost of operation of the carbon capture device. Additionally, rainwater collection may reduce a net water requirement of the carbon capture device.

Further, the containment system may neutralize any spillage received from the carbon capture device, thereby preventing damage to the environment around the site. Thus, the containment system of the present disclosure may not only provide a natural bunded area for purification of the fluid but also for rainwater collection and purification. The fluid (e.g., water) after purification exiting the at least one secondary bund may be channelized and used again in the carbon capture device, thereby mitigating water loss from the spill of the process fluid. The containment system may also add to a natural ecosystem around the site through the at least one first plant species, such that the carbon capture device not only functions as a net carbon sink but also as a net positive for the natural ecosystem.

The containment system utilizes a natural wastewater treatment approach while encouraging biodiversity and collecting the rainwater from a large area around the carbon capture device and also in the area of the primary bund and the at least one secondary bund.

In some embodiments, the containment system further includes a conduit fluidly communicating the at least one secondary bund with the carbon capture device. In some embodiments, the conduit is configured to provide at least a portion of the fluid at least partially filtered by the at least one secondary bund to the carbon capture device for use by the carbon capture device. Thus, the carbon capture device may reuse at least the portion of the fluid (e.g., water) after filtration to further reduce the cost of operation of the carbon capture device.

In some embodiments, the primary bund includes a primary open tank defining a primary inner surface. In some embodiments, the primary bund further includes a primary fluid impermeable layer disposed on the primary inner surface of the primary open tank. The primary fluid impermeable layer may prevent leakage of the fluid from the primary open tank, e.g., into the environment around the carbon capture device.

In some embodiments, the containment system further includes at least one aggregate at least partially filling the primary bund and at least one second plant species at least partially embedded in the at least one aggregate. The at least one aggregate and the at least one second plant species are together configured to at least partially filter the fluid. Thus, the at least one aggregate and the at least one second plant species may function as a first stage natural wastewater treatment system for the fluid followed by filtration from the at least one secondary bund. The primary bund may therefore be considered as a primary filter bed.

In some embodiments, the at least one second plant species is different from the at least one first plant species. Thus, the containment system may promote biodiversity at the site. Biodiversity may further enhance a net negative carbon value of the site.

In some embodiments, the at least one second plant species includes common reed. Common reed is known to provide an excellent root system for holding the at least one aggregate (or sand, gravel, etc.) together and enable filtering. Additionally, common reed is known to function as a carbon sink as the vegetation grows. This may provide additional benefit for the net negative carbon value of the site. Further, the common reed may be preferred due to its widespread availability.

In some embodiments, the at least one secondary bund includes a secondary open tank defining a secondary inner surface. In some embodiments, the at least one secondary bund further includes a secondary fluid impermeable layer disposed on the secondary inner surface of the secondary open tank. The secondary fluid impermeable layer may prevent leakage of the fluid from the secondary open tank, e.g., into the environment around the carbon capture device.

In some embodiments, the containment system further includes at least one gate fluidly disposed between the primary bund and the at least one secondary bund. In some embodiments, the at least one gate is configured to control a flow of the fluid therethrough. Thus, the at least one gate may be controlled to selectively allow the flow of the fluid to the at least one secondary bund. Further, the at least one gate may isolate the primary bund in an event of a major spillage from the carbon capture device.

In some embodiments, the at least one secondary bund includes a plurality of secondary bunds disposed in fluid communication with each other. Thus, the portion of the fluid received within each of the plurality of secondary bunds may be sequentially filtered by the corresponding secondary bund. The plurality of secondary bunds may progressively filter the fluid, thereby providing a multi-stage filtration of the fluid.

In some embodiments, each secondary bund from the plurality of secondary bunds includes a corresponding at least one first plant species. In some embodiments, the at least one first plant species of the plurality of secondary bunds are different from each other.

Thus, the plurality of secondary bunds may provide a natural habitat for a range of natural species and may improve the biodiversity of the site. The containment system may function as the natural wastewater treatment system while ensuring that an overall net biodiversity of the site is improved by actively promoting a thriving water-based environment. Further, the containment system may be designed to emulate natural local wetland habitats using similar species to ensure that the biodiversity which is encouraged is compatible with the locality.

According to a second aspect, there is provided a carbon capture system. The carbon capture system includes a carbon capture device including an absorber, a desorber, and a process fluid flowing at least between the absorber and the desorber. The carbon capture system further includes the containment system of the first aspect. The primary bund at least partially surrounds the absorber and the desorber. The primary bund is configured to receive the process fluid spilled from the absorber and the desorber.

According to a third aspect, there is provided a method of containing a spill of a process fluid from a carbon capture device. The method includes providing a primary bund at least partially surrounding the carbon capture device. The method further includes providing at least one secondary bund in fluid communication with the primary bund. The method further includes providing at least one first plant species within the at least one secondary bund. The method further includes receiving a rainwater and the process fluid spilled from the carbon capture device within the primary bund to at least partially form a fluid stored within the primary bund. The method further includes receiving at least a portion of the fluid stored within the primary bund into the at least one secondary bund. The method further includes at least partially filtering the portion of the fluid received within the secondary bund by the at least one first plant species.

In some embodiments, the method further includes providing, via a conduit, at least a portion of the fluid at least partially filtered by the at least one secondary bund to the carbon capture device for use by the carbon capture device.

In some embodiments, the method further includes providing at least one second plant species within the primary bund. In some embodiments, the method further includes at least partially filtering the fluid within the primary bund by the at least one first plant species.

In some embodiments, the method further includes controlling, via at least one gate, a flow of the fluid between the primary bund and the at least one secondary bund.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 is a schematic view of a carbon capture system, according to an embodiment of the present disclosure;

FIG. 2 is a schematic view of the carbon capture system, according to another embodiment of the present disclosure; and

FIG. 3 is a flow chart illustrating a method of containing a spill of a process fluid from a carbon capture device, according to an embodiment of the present disclosure.

### DETAILED DESCRIPTION

Aspects and embodiments of the present disclosure will now be discussed with reference to the accompanying figures. Further aspects and embodiments will be apparent to those skilled in the art.

Chemical elements are discussed in the present disclosure using their common chemical abbreviations, such as commonly found on a periodic table of elements. For example, hydrogen is represented by its common chemical abbreviation H; helium is represented by its common chemical abbreviation He; and so forth.

As used herein, the term “wetland” generally refers to a sector on the ground that is at least partially separated from surroundings and characterized by higher water content and presence of hygrophilous plants, or other types of plants.

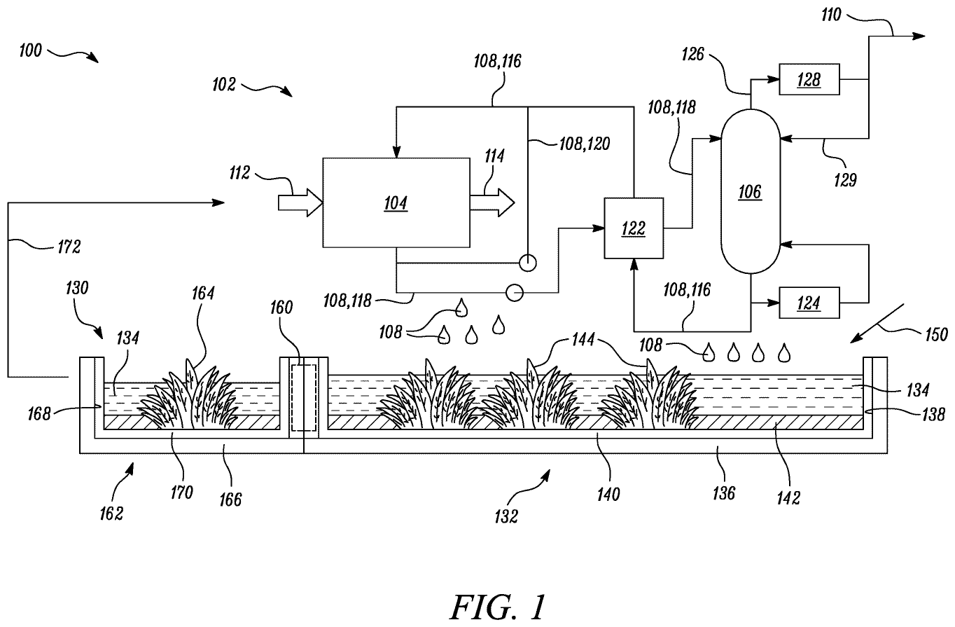

FIG. 1 illustrates a schematic view of a carbon capture system 100. The carbon capture system 100 includes a carbon capture device 102 including an absorber 104, a desorber 106, and a process fluid 108 flowing at least between the absorber 104 and the desorber 106. In some examples, the carbon capture device 102 may be used to capture carbon directly from a carbon dioxide (CO₂) containing gas (e.g., air). This technique may be referred to as direct air capture (DAC) of atmospheric CO₂.

In some embodiments, the absorber 104 receives a CO₂ containing gas stream from an inlet 112 and discharges the gas stream from an outlet 114 after processing. In some embodiments, a sorbent flows through the absorber 104. A portion of the sorbent, i.e., a lean stream 116, enters the absorber 104, contacts the CO₂ containing gas stream, and becomes a rich stream 118 after leaving the absorber 104. In some embodiments, a portion of the sorbent may be recirculated within the absorber 104 as a recirculation stream 120, which may increase an effective residence time of the lean stream 116 of the sorbent in the absorber 104.

In some embodiments, the rich stream 118 is passed through a heat exchanger 122 to recover a portion of a heat from the lean stream 116 returning from the desorber 106. In some embodiments, the desorber 106 receives the rich stream 118 and heats up the rich stream 118 to a temperature at which the CO₂ absorbed by the rich stream 118 may be released from the sorbent. In some embodiments, the rich stream 118 may be heated using a heating means 124, which may also generate steam to form vapour bubbles into which desorbed CO₂ may diffuse, leaving the lean stream 116 of sorbent to return to the absorber 104 to repeat the process.

In some embodiments, a mixture of the vapour and the desorbed CO₂ exits the desorber 106 as an output stream 126, where a condenser 128 is used to cool the mixture causing the vapour to condense and return to the desorber 106 via a stream 129 leaving behind a purer CO₂ product stream 110. In some embodiments, the process fluid 108 may be any of the fluid streams of the carbon capture device 102, i.e., the lean stream 116, the rich stream 118, and the recirculation stream 120.

It should be understood that the carbon capture device 102 is shown in FIG. 1 by way of example only, and various other variations of the carbon capture device 102 are within the scope of the disclosure. For example, the carbon capture device 102 may include multiple absorbers 104 and/or desorbers 106 suitably arranged based on application requirements.

The carbon capture system 100 further includes a containment system 130. The containment system 130 includes a primary bund 132 at least partially surrounding the absorber 104 and the desorber 106. In some embodiments, the primary bund 132 may be in the form of a tank or a reservoir disposed on the ground. In some embodiments, the primary bund 132 may be made of concrete. However, it should be understood that the primary bund 132 may be made from any suitable material based on application requirements.

The primary bund 132 is configured to receive therein the process fluid 108 spilled from the absorber 104 and the desorber 106. For example, the primary bund 132 is configured to receive the process fluid 108 in case of leakage in the carbon capture device 102, e.g., through the associated pipework, tanks, equipment, etc. In some embodiments, the primary bund 132 may be appropriately positioned underneath the absorber 104 and the desorber 106 to be able to capture any process fluid 108 in an event of spill.

The primary bund 132 is further configured to receive therein a rainwater 150. In some embodiments, the primary bund 132 is open to collect the rainwater 150 runoff from the carbon capture device 102 or associated regions around the carbon capture device 102. The rainwater 150 and the process fluid 108 spilled from the carbon capture device 102 at least partially form a fluid 134 stored within the primary bund 132. In some embodiments, a top surface of the carbon capture device 102 or the associated components may be designed to reflect away excessive solar irradiation to limit the insolation of the site, e.g., to mitigate evaporation of the collected rainwater 150.

In some embodiments, the primary bund 132 includes a primary open tank 136 defining a primary inner surface 138. In some embodiments, the primary bund 132 further includes a primary fluid impermeable layer 140 disposed on the primary inner surface 138 of the primary open tank 136. In some embodiments, the primary fluid impermeable layer 140 may prevent leakage of the fluid 134 from the primary open tank 136, e.g., into an environment around the carbon capture device 102.

In some embodiments, the primary fluid impermeable layer 140 may include concrete in case of high concentration localised spillage. In some embodiments, the primary fluid impermeable layer 140 may include natural clay. In some other embodiments, the primary fluid impermeable layer 140 may be made of a polymeric material, such as a plastic or a recycled plastic.

Thus, the primary bund 132 may function as a first containment measure for any leakage through the carbon capture device 102. Further, the primary bund 132 may mitigate environmental impact of the process fluid 108 due to the spillage by diluting the process fluid 108 with the rainwater 150. For example, the rainwater 150 may neutralize the process fluid 108 by bringing its pH closer to 7 as well as reducing a concentration of the process fluid 108. In some embodiments, the rainwater 150 may be stored in tanks within the primary bund 132 that may be released in the event of spill.

In some embodiments, the containment system 130 further includes at least one aggregate 142 at least partially filling the primary bund 132 and at least one second plant species 144 at least partially embedded in the at least one aggregate 142. In some embodiments, the at least one aggregate may include gravel, sand, peat, turf, soil, etc. In some embodiments, the at least one second plant species 144 may be planted in the at least one aggregate 142.

In some embodiments, the at least one aggregate 142 and the at least one second plant species 144 are together configured to at least partially filter the fluid 134. Thus, the at least one aggregate 142 and the at least one second plant species 144 may function as a first stage natural wastewater treatment for the fluid 134. The primary bund 132 may therefore be considered as a primary filter bed. Each of the first and second plant species may provide some filtration by its root structure and also provide a structure or habitat for supporting microorganisms that break down pollutants. In this disclosure mention of plant species includes the root system of the plant and the microorganisms that are supported by the plant and help to break down pollutants. Supplying a plant species to a bund may include introducing microorganisms to the bund which are selected to breakdown the anticipated pollutants that may leak or be spilled from the carbon capture facility.

For example, the sorbent used in the direct air capture plant may comprise an amino acid salt or an amine such as monoethanolamine. Some microorganisms such as bacteria are able to break down these sorbents and use them as an energy source. The bund may be pre-stocked with bacteria that have been selected to effectively breakdown the sorbent so that environmental protection is available immediately the carbon capture plant is operational. During operation of the plant, periodically testing the effectiveness of the bacteria living in the bund to breakdown the sorbent is then used to implement remedial action to top up the bacteria stock to maintain the bund effectiveness.

In some embodiments, the at least one second plant species 144 may include multiple varieties of plant species. In some embodiments, the at least one second plant species 144 may be chosen based on compatibility with the locality, i.e., based on environmental and/or weather conditions of the site. In some embodiments, the at least one second plant species 144 includes common reed (phragmites australis), a hygrophilous plant. However, other similar plant species may also be utilized.

Other non-limiting examples of the hygrophilous plant species that may be utilized include bulrushes (Scirpus spp.), rushes (Juncus spp.), cattails (Typha spp.), reed canary-grass (Phalaris arundinacea), sweet mannagrass (Glyceria maxima), alligator weed (Alternanthera philoxeroides), Canna lilies (Canna spp.), sedges (Carex app), coontail (Ceratophyllum spp.), sawgrass (Cladium jamaicense), wild taro (Colocasia esculenta), sedges (Cyperus spp.), spikerushes (Eleocharis spp.), waterweed (Elodea spp.), mannagrass (Glyceria spp.), watergrass (Hydrocloa caroliniensis), iris or blue flag iris (Iris spp.), duckweed (Lemna spp.), water primroses (Ludwigia spp.), maidencane (Panicum hemitomon), torpedo grass (Panicum repens), spoon flowers (Peltandra spp.), smartweeds (Polygonum spp.), pickerelweeds (Pontederia spp.), beak-rush (Rhynchospora spp.), arrowheads (Sagittaria spp.), Lizard's-tail (Saururus cernuus), bur-reed (Sparaganium spp.), arrowroot (Thalia geniculata), cattail/reedmace/bulrush (Typha spp.), wild rice (Zizania aquatica), and southern wild rice (Zizaniopsis milacea).

Common reed is known to provide excellent root system for holding the at least one aggregate 142 (or sand, gravel, etc.) together and enable filtering. Typically, the common reed has the ability to transfer oxygen from its leaves, down through its stem, and out via its root system. As a result, a very high population of microorganisms may be present in or around the root system of the common reed. Thus, the common reed may provide a habitat for such microorganisms to thrive.

As the fluid 134 moves gradually through the common reed, natural biological, physical, and chemical processes interact with one another in the root system of the common reed to degrade or break down pollutants within the fluid 134, thereby filtering the fluid 134. Specifically, the microorganisms present in or around the root system of the common reed may aid in the filtration of the fluid 134. Additionally, the common reed is known to function as a carbon sink as the vegetation grows. This may provide additional benefit for a net negative carbon value of the site. Further, the common reed may be preferred due to its widespread availability.

In some embodiments, the absorber 104 and/or the desorber 106 may be built above the primary bund 132 on stilts or other similar structure that may allow the at least one second plant species 144 (i.e., the common reed or equivalent) to grow directly underneath. Alternatively, a height of the primary bund 132 may be kept low to allow the at least one second plant species 144 to grow directly underneath the absorber 104 and/or the desorber 106. An access strategy for the site may be designed accordingly.

In alternative embodiments, a hot side of the carbon capture device 102 (including the desorber 106, the heat exchanger 122, and related equipment) may not be located above the primary bund 132 having the at least one aggregate 142 and the at least one second plant species 144. Instead, the area underneath the hot side of the carbon capture device 102 may be bunded as usual (with an impermeable layer) that feeds the primary bund 132.

The containment system 130 further includes at least one secondary bund 162 disposed in fluid communication with the primary bund 132. In the illustrated embodiment FIG. 1, the at least one secondary bund 162 includes a single secondary bund 162. The at least one secondary bund 162 is configured to receive therein at least a portion of the fluid 134 stored within the primary bund 132.

In some embodiments, the at least one secondary bund 162 may be in the form of a tank or a reservoir disposed on the ground. In some embodiments, the at least one secondary bund 162 may be made of concrete. However, it should be understood that the at least one secondary bund 162 may be made from any suitable material based on application requirements.

In some embodiments, the containment system 130 further includes at least one gate 160 (e.g., sluice gates or similar) fluidly disposed between the primary bund 132 and the at least one secondary bund 162. In some embodiments, the at least one gate 160 is configured to control a flow of the fluid 134 therethrough. Thus, the at least one gate 160 may be controlled to selectively allow the flow of the fluid 134 to the at least one secondary bund 162. Further, the at least one gate 160 may isolate the primary bund 132 in an event of major spillage from the carbon capture device 102.

In some embodiments, the at least one secondary bund 162 includes a secondary open tank 166 defining a secondary inner surface 168. In some embodiments, the at least one secondary bund 162 further includes a secondary fluid impermeable layer 170 disposed on the secondary inner surface 168 of the secondary open tank 166. In some embodiments, the secondary fluid impermeable layer 170 may be similar to the primary fluid impermeable layer 140. For example, the secondary fluid impermeable layer 170 may be made of concrete, natural clay, polymeric material, etc. In some embodiments, the secondary fluid impermeable layer 170 may prevent leakage of the fluid 134 from the secondary open tank 166, e.g., into the environment around the carbon capture device 102.

The containment system 130 further includes at least one first plant species 164 disposed within the at least one secondary bund 162. The at least one first plant species 164 is configured to at least partially filter the portion of the fluid 134 received within the at least one secondary bund 162. In some embodiments, the at least one first plant species 164 may include naturally planted beds that may at least partially filter the portion of the fluid 134 received within the at least one secondary bund 162.

In some embodiments, the at least one first plant species 164 may be similar to the at least one second plant species 144 described above. In some embodiments, microorganisms present in root system of the at least one first plant species 164 may help degrade or break down pollutants within the portion of the fluid 134 received within the at least one secondary bund 162, thereby filtering the portion of the fluid 134. For example, the at least one secondary bund 162 may further break down the low-level concentration of the process fluid 108 in the portion of the fluid 134 received within the at least one secondary bund 162 and may simultaneously filter, clean, and purify the portion of the fluid 134. It should be understood that the at least one first plant species 164 may include any plant species and the associated microorganisms in the root system capable of at least partially filtering the fluid 134 received within the at least one secondary bund 162.

In alternative embodiments, the secondary inner surface 168 may be free from any impermeable layer, thereby allowing the portion of the fluid 134 received within the at least one secondary bund 162 to be slowly discharged after filtration through the at least one secondary bund 162.

In some embodiments, the at least one first plant species 164 may include multiple varieties of plant species. In some embodiments, the at least one first plant species 164 may be chosen based on compatibility with the locality, i.e., based on environmental and/or weather conditions of the site. In some embodiments, the at least one second plant species 144 is different from the at least one first plant species 164. Thus, the containment system 130 may promote a biodiversity at the site. Biodiversity may further enhance the net negative carbon value of the site.

Thus, the containment system 130 of the present disclosure may neutralize any spillage received from the carbon capture device 102, thereby preventing damage to the environment around the site. The containment system 130 may not only provide a natural bunded area for purification of the fluid 134 but also for rainwater collection and purification. Runoff from the primary bund 132 may be subsequently filtered by the at least one secondary bund 162 akin to a natural wastewater treatment system, thereby reducing a need to clean the fluid 134 through specialist waste contractors. This may reduce an overall cost of operation of the carbon capture device 102. Additionally, rainwater collection may reduce a net water requirement of the carbon capture device 102.

This invention is predicated on the process fluid 108 being non-toxic, and if diluted with the rainwater 150, the resulting mixture (i.e., the fluid 134) may be of an acceptable pH for natural filtration and processing.

In some embodiments, the containment system 130 further includes a conduit 172 fluidly communicating the at least one secondary bund 162 with the carbon capture device 102. In some embodiments, the conduit 172 is configured to provide at least a portion of the fluid 134 at least partially filtered by the at least one secondary bund 162 to the carbon capture device 102 for use by the carbon capture device 102.

The portion of the fluid 134 at least partially filtered by the at least one secondary bund 162 may be used in the carbon capture device 102 as process water, cleaning water, or other water needs both on and off-site. Thus, the carbon capture device 102 may reuse at least the portion of the fluid 134 (e.g., water) after filtration to further reduce the cost of operation of the carbon capture device 102.

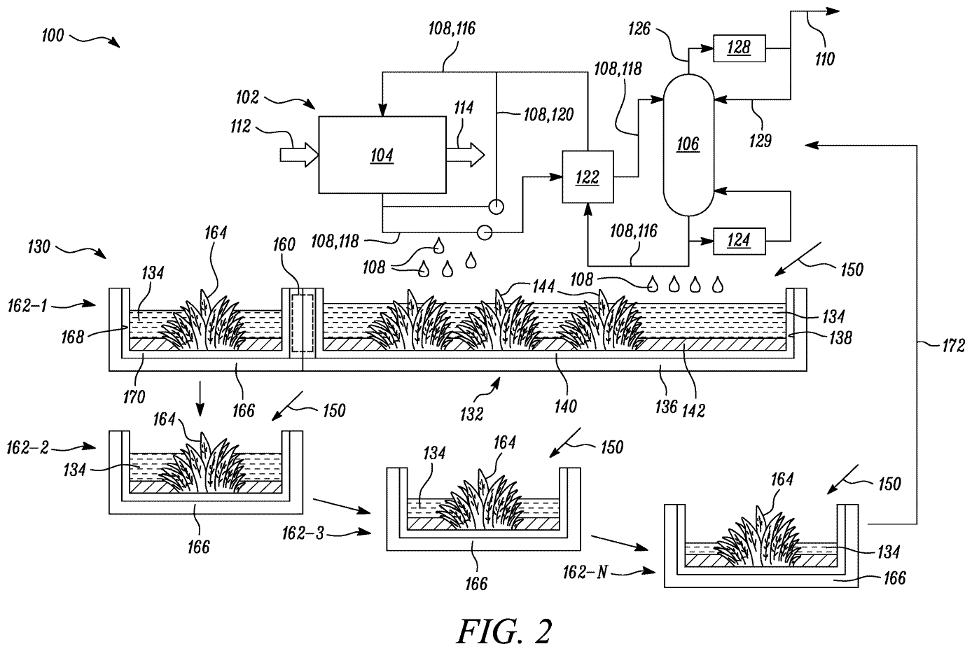

FIG. 2 is a schematic view of the carbon capture system 100, according to another embodiment of present disclosure. In the illustrated embodiment of FIG. 2, the at least one secondary bund 162 includes a plurality of secondary bunds 162-1, 162-2, . . . , 162-N (collectively, secondary bunds 162) disposed in fluid communication with each other, where N is a positive integer corresponding to a total number of secondary bunds 162 (e.g., N=10, 20, etc.). In some embodiments, each of the plurality of secondary bunds 162 may also receive the rainwater 150 since the plurality of secondary bunds 162 may be open to receive the rainwater 150.

In some embodiments, each secondary bund 162 from the plurality of secondary bunds 162 includes a corresponding at least one first plant species 164. In some embodiments, the at least one first plant species 164 of the plurality of secondary bunds 162 are different from each other. Thus, the plurality of secondary bunds 162 may provide a natural habitat for a range of natural species and may serve to improve the biodiversity of the site. The containment system 130 may function as the natural wastewater treatment system while ensuring that an overall net biodiversity of the site is improved by actively promoting a thriving water-based environment. Further, the containment system 130 may be designed to emulate natural local wetland habitats using similar species to ensure that the biodiversity which is encouraged is compatible with that locality.

In alternative embodiments, some of the plurality of secondary bunds 162 may not include the at least one first plant species 164. Further, some of the plurality of secondary bunds 162 may be unbounded and may not include any tank or reservoir. Further, the portion of the fluid 134 received within the plurality of secondary bunds 162 may mix with a soil surface and/or ponds adjacent to the site.

Optionally, the containment system 130 may further include one or more gates (not shown) fluidly disposed between the adjacent secondary bunds 162 from the plurality of secondary bunds 162. The one or more gates may control a flow of the fluid 134 therethrough. The plurality of secondary bunds 162 may progressively filter the fluid 134, thereby providing a multi-stage filtration of the fluid 134. In the illustrated embodiment of FIG. 2, the conduit 172 fluidly communicates the final bund (i.e., the secondary bund 162-N) with the carbon capture device 102.

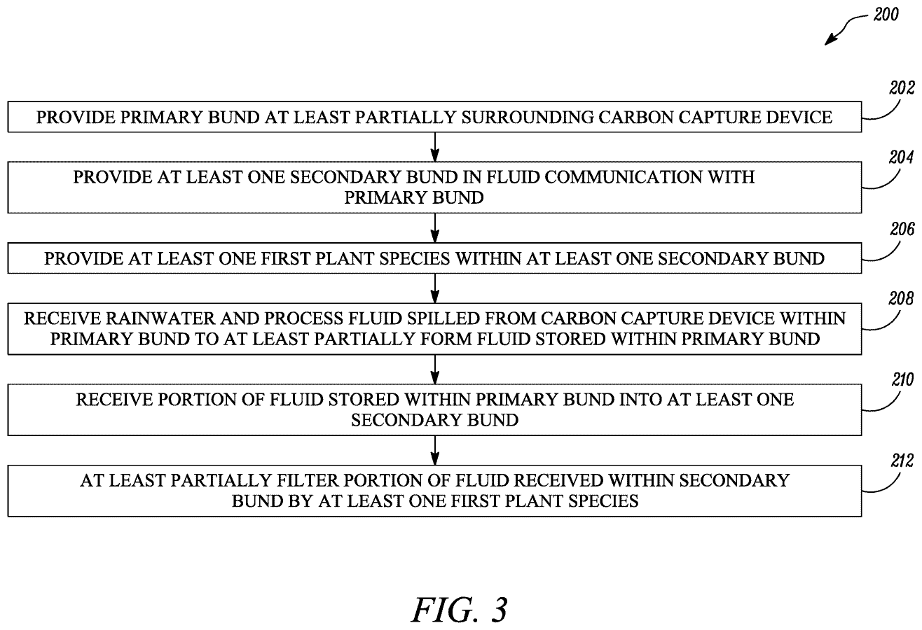

FIG. 3 is a flow chart illustrating a method 200 of containing the spill of the process fluid 108 from the carbon capture device 102. The method 200 will be described hereinafter with reference to the carbon capture system 100 of FIGS. 1 and 2.

At step 202, the method 200 includes providing the primary bund 132 at least partially surrounding the carbon capture device 102. In some embodiments, the method 200 further includes providing the at least one second plant species 144 within the primary bund 132. At step 204, the method 200 further includes providing the at least one secondary bund 162 in fluid communication with the primary bund 132. At step 206, the method 200 further includes providing the at least one first plant species 164 within the at least one secondary bund 162.

At step 208, the method 200 further includes receiving the rainwater 150 and the process fluid 108 spilled from the carbon capture device 102 within the primary bund 132 to at least partially form the fluid 134 stored within the primary bund 132. In some embodiments, the method 200 further includes at least partially filtering the fluid 134 within the primary bund 132 by the at least one second plant species 144.

At step 210, the method 200 further includes receiving at least a portion of the fluid 134 stored within the primary bund 132 into the at least one secondary bund 162. In some embodiments, the method 200 further includes controlling, via the at least one gate 160, a flow of the fluid 134 between the primary bund 132 and the at least one secondary bund 162. At step 212, the method 200 further includes at least partially filtering the portion of the fluid 134 received within the secondary bund 162 by the at least one first plant species 164.

In some embodiments, the method 200 further includes providing, via the conduit 172, at least a portion of the fluid 134 at least partially filtered by the at least one secondary bund 162 to the carbon capture device 102 for use by the carbon capture device 102.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A containment system for a carbon capture device, the containment system comprising:
a primary bund at least partially surrounding the carbon capture device and configured to receive therein a process fluid spilled from the carbon capture device and a rainwater, the rainwater and the process fluid spilled from the carbon capture device at least partially forming a fluid stored within the primary bund;
at least one secondary bund disposed in fluid communication with the primary bund, wherein the at least one secondary bund is configured to receive therein at least a portion of the fluid stored within the primary bund; and
at least one first plant species disposed within the at least one secondary bund, wherein the at least one first plant species is configured to provide filtration of the portion of the fluid received within the at least one secondary bund.

2. The containment system of claim 1, further comprising a conduit fluidly communicating the at least one secondary bund with the carbon capture device, wherein the conduit is configured to provide at least a portion of the fluid at least partially filtered by the at least one secondary bund to the carbon capture device for use by the carbon capture device.

3. The containment system of claim 1, wherein the primary bund comprises:
a primary open tank defining a primary inner surface; and
a primary fluid impermeable layer disposed on the primary inner surface of the primary open tank.

4. The containment system of claim 1, further comprising at least one aggregate at least partially filling the primary bund and at least one second plant species at least partially embedded in the at least one aggregate, wherein the at least one aggregate and the at least one second plant species are together configured to at least partially filter the fluid.

5. The containment system of claim 4, wherein the at least one second plant species is different from the at least one first plant species.

6. The containment system of claim 5, wherein the at least one second plant species comprises common reed.

7. The containment system of claim 1, wherein the at least one secondary bund comprises:
a secondary open tank defining a secondary inner surface; and
a secondary fluid impermeable layer disposed on the secondary inner surface of the secondary open tank.

8. The containment system of claim 1, further comprising at least one gate fluidly disposed between the primary bund and the at least one secondary bund, wherein the at least one gate is configured to control a flow of the fluid therethrough.

9. The containment system of claim 1, wherein the at least one secondary bund comprises a plurality of secondary bunds disposed in fluid communication with each other.

10. The containment system of claim 9, wherein each secondary bund from the plurality of secondary bunds comprises a corresponding at least one first plant species, and wherein the at least one first plant species of the plurality of secondary bunds are different from each other.

11. A carbon capture system comprising:
a carbon capture device comprising an absorber, a desorber and a process fluid flowing at least between the absorber and the desorber; and
the containment system of claim 1, wherein the primary bund at least partially surrounds the absorber and the desorber, and wherein the primary bund is configured to receive therein the process fluid spilled from the absorber and the desorber.

12. A method of containing a spill of a process fluid from a carbon capture device, the method comprising:
providing a primary bund at least partially surrounding the carbon capture device;
providing at least one secondary bund in fluid communication with the primary bund;
providing at least one first plant species within the at least one secondary bund;
receiving a rainwater and the process fluid spilled from the carbon capture device within the primary bund to at least partially form a fluid stored within the primary bund;
receiving at least a portion of the fluid stored within the primary bund into the at least one secondary bund; and
at least partially filtering the portion of the fluid received within the secondary bund by the at least one first plant species.

13. The method of claim 12, further comprising providing, via a conduit, at least a portion of the fluid at least partially filtered by the at least one secondary bund to the carbon capture device for use by the carbon capture device.

14. The method of claim 12, further comprising:
providing at least one second plant species within the primary bund; and
at least partially filtering the fluid within the primary bund by the at least one second plant species.

15. The method of claim 12, further comprising controlling, via at least one gate, a flow of the fluid between the primary bund and the at least one secondary bund.
